(19) United States
(12) Patent Application Publication
(10) Pub. No.: US 2021/0003100 A1
(43) Pub. Date: Jan. 7, 2021

(54) WATER-FUEL EMULSION AND FUEL TREATMENT METHOD

(71) Applicant: Oleksandr Yuriiovych Mykytiuk, Kyiv (UA)

(72) Inventor: Oleksandr Yuriiovych Mykytiuk, Kyiv (UA)

(21) Appl. No.: 16/976,441

(22) PCT Filed: Feb. 15, 2019
(86) PCT No.: PCT/UA2019/000023

§ 371 Date: Aug. 27, 2020

(30) Foreign Application Priority Data
Feb. 28, 2018 (UA) A 2018 02094

(51) Int. Cl. F02M 25/022; C10L 10/02; C10L 1/32; C10L 1/12

(52) U.S. Cl. CPC F02M 25/0228; C10L 10/02; C10L 2250/084; C10L 1/1208; C10L 2200/024; C10L 1/328

(57) ABSTRACT

Declared composition of the fuel-water emulsion and the method of treating the fuel before combustion in a developed cavitation mode are designed to reduce emissions of exhaust and greenhouse gases of internal combustion engines and boilers using diesel fuel and other types of liquid hydrocarbon fuels.

The claimed invention relates to the fuel-power field and it may be used as a method for purifying gases, which are formed in internal combustion engines and boiler units when using diesel and other types of liquid carbon fuels, from harmful substances.

A method for purifying exhaust gases of an internal combustion engine is known, the method includes preparing a catalysis, contacting a catalyst with the exhaust gases, characterized in that a dust that is formed during abrasive treatment of articles made of copper and/or copper alloys is used as the catalyst (patent of Ukraine No. 56431, publ. on 15 May 2003).

Also, these are known:
a method for purifying exhaust gases of an internal combustion engine is known, the method lies in preparing a catalysis, contacting a catalyst with the exhaust gases, characterized in that a dust that is formed during welding aerosol entrapment is used as the catalyst (patent of Ukraine No. 56460, publ. on 15 May 2003);
a method for purifying exhaust gases of engines from harmful impurities that includes feeding water to a device for purifying exhaust gases, transforming the water into vapor, adsorbing particles of solid and liquid impurities by the water vapor thereby forming dripping conglomerates, collecting these conglomerates on a filter, as well as contacting the gaseous impurities with catalysts followed by their oxidizing up to carbon dioxide and reducing up to atomic nitrogen, the method is characterized in that the purification of the gases is carried out in two consecutively performed stages by passing the exhaust gases through consecutively connected reaction chamber and collection filter, wherein on the first stage of purification the water is fed by pulverization followed by vapor formation, interaction of the water vapor with carbon oxide thereby forming the carbon dioxide and hydrogen and reducing nitrogen oxides by this hydrogen, and on the second stage of purification the formed dripping conglomerates and sulfur impurities are collected on the collection filter (patent of Ukraine No. 37389, publ. on 15 May 2001);
a method for regulating a content of nitrogen oxides in flue gases of a boiler unit by introducing water into a combustion space and altering the fed water consumption according to a parameter that characterizes a burning process, the method is characterized in that in order to increase the efficiency of the boiler unit that has a contact air heater, the water that is introduced into the combustion space fed to the contact air heater, mixed with a blasting air and fed into the combustion space in the form of a condensed moisture that is retained in the blasting air; the fed water consumption is regulated by separating an excessive condensed moisture at the output of the contact air heater, while the nitrogen oxides content in the flue gases at the output of the boiler unit is used as the parameter that characterizes the burning process (patent of Ukraine No. 14051, publ. on 25 Apr. 1997);

Main drawbacks of all of the above-mentioned methods (analogues) are the following:
inability to effectively reduce the volume of harmful and greenhouse gases emission in the process of fuel burning;
necessity of using additional devices or catalysts for reducing harmful and greenhouse gases emission;
necessity to use stabilizers and emulsifiers;
inability to reduce the volume of the fuel used;
inability to increase the efficiency of the fuel burning for up to 100%;
necessity of introducing structural changes to the internal combustion engine or boiler unit.

The closest analogue that is chosen as a prototype is a method for preparing a fuel for an internal combustion engine, the method is based on mixing petrol or diesel fuel with water or alcohol, or with a mixture thereof, with an emulsifier and with a stabilizer. What is novel is that the water or the alcohol, or the mixture thereof, is supplemented by introducing a colloidal solution of metal nanoparticles agglomerates obtained by an erosion-explosive dispersion of metal granules correspondingly in the water, in the alcohol or in the mixture thereof, wherein the nanoparticles are in the amorphous state, wherein the metal nanoparticles agglomerates are formed by nanoparticles of at least two dissimilar metals and form short-circuited nanogalvanic elements, and the metals are selected from the group that consists of silver, gold, copper, nickel, palladium, platinum, molybdenum, cobalt, rhodium, vanadium, iron, manganese, chromium, zinc, tin, zirconium, titanium, aluminum, magnesium, gallium, stibium, selenium, terbium, praseodymium, samarium, gadolinium, cerium, lanthanum, yttrium, neodymium, and the components are taken in the following ratios, wt. %:
petrol or diesel fuel 65-95
water or alcohol or a mixture thereof 2-25
colloidal solution of metal nanoparticles with the nanoparticles content of 0.00001-0.01 2-10
emulsifier 0.5-1
stabilizer 0.01-0.4
   wherein the alcohol content in the water-alcohol mixture is 0-100 wt. % (patent of Ukraine No. 30738, publ. on 11 Mar. 2008).

Drawbacks of the prototype are the following:
necessity to use stabilizers and emulsifiers;
inability to effectively reduce the volume of harmful and greenhouse gases emission in the process of fuel burning;
inability to reduce the volume of the fuel used;
inability to increase the efficiency of the fuel burning for up to 100%.

The claimed invention is aimed at reduction of harmful and greenhouse gases emission of internal combustion engines and boiler units having an opened plume, which are formed during combustion of the fuel without adding compounds, which are harmful for the engine or boiler unit and for the environment. In particular, to achieve effective reduction of emission of sulfur dioxide, carbon monoxide and nitrogen oxides, which are present in exhaust gases, without loss of the engine or boiler unit operation efficiency. Further problem of the claimed invention is to increase the efficiency of fuel combustion in internal combustion engines or boiler units having an opened plume for up to 100%.

The stated purpose is achieved by two variants, in particular, by treatment of the fuel (according to the first variant) and by treatment of the fuel-water emulsion (according to the second variant) resulting in changing their physical and chemical properties that leads to novel features of the fuel combustion process, resulting in solving the stated technical problem.

Variant 1. During activation of the fuel in the developed cavitation mode under the temperature of from 0° C. to 70° C. and pressure of from 1 to 3 atm without adding any impurities the physical and chemical properties of the fuel are changed due to breakage of inter- and intramolecular bonds that leads to:

(1) reduction of the volume of the fuel used by 1%-4% for carrying out a work that is equal to the work with the use of initial fuel, without loss of the operation efficiency of the engine or boiler unit, that reduces volumes of harmful gases emission;

(2) increase of fuel combustion efficiency for up to 100% that occurs due to reduction of high-molecular substances fraction in the activated fuel in favor of medium and low-molecular ones, as well as due to reduction of the energy of intermolecular bonds in the fuel and destruction of the intermolecular clusters;

(3) increase of efficiency of use of air oxygen that is necessary for the fuel combustion that leads to reduction of the volume of the air consumed being necessary for combustion of the volume of the activated fuel that is equal to the volume of the non-activated fuel, and to the corresponding reduction of the nitrogen volume that achieves the combustion chamber and forms nitrogen oxides;

(4) chemical modification of sulfur-containing molecules, which are comprised in the fuel, that facilitates formation of molecular sulfur during combustion of the fuel that is condensed after combustion of the activated fuel.

Variant 2. During treatment of the fuel in the developed cavitation mode with adding of aqueous suspension of iron-containing compounds a breakage of inter- and intramolecular bonds occurs that leads to change of physical and chemical properties of the fuel and formation of a stable fuel-water emulsion without use of stabilizers and/or emulsifiers. Use of the obtained fuel-water emulsion as the fuel leads to:

(1) reduction of the volume of the carbon fuel used by 4%-10% for carrying out a work that is equal to the work with the use of initial fuel, without loss of the operation efficiency of the engine or boiler unit, that reduces volumes of harmful gases emission;

(2) increase of fuel combustion efficiency for up to 100% that occurs due to reduction of high-molecular substances fraction in the activated fuel in favor of medium and low-molecular ones, as well as due to reduction of the energy of intermolecular bonds in the fuel and destruction of the intermolecular clusters;

(3) increase for up to 10% of the efficiency of air oxygen usage and additional usage of oxygen that is released during high-temperature decomposition of water molecules, which are comprised in the fuel-water emulsion, that leads to reduction of the volume of nitrogen oxides in the exhaust and flue gases that is necessary for the fuel combustion that leads to reduction of the volume of the air consumed being necessary for combustion of the volume of the activated fuel, and to the corresponding reduction of the nitrogen volume that achieves the combustion chamber and forms nitrogen oxides;

(4) substitution of a portion of the air oxygen with the oxygen that releases from the water molecules during high-temperature decomposition of the water molecules in the fuel combustion area that leads to reduction of the air volume and, thus, to the reduction of volumes of formation of the nitrogen oxides;

(5) chemical modification of sulfur-containing molecules, which are comprised in the fuel, that facilitates formation of molecular sulfur during combustion of the fuel that is condensed after combustion of the activated fuel;

(6) release of additional energy of the hydrogen oxidation that derives from water molecules during combustion of the fuel-water emulsion that leads to reduction of fuel consumption for performing similar work.

The fuel-water emulsion according to the second variant is a part of the present invention and represents a raw material for producing a ready (activated) water-fuel emulsion and it consists of a liquid fuel itself and a hydrogenous suspension that, in turn, consists of mineral compounds of iron with a concentration of from 0.0001% to 0.1%, wherein the suspension volume is 0.5-40% of the fuel volume. The suspension volume in the ready (activated) water-fuel emulsion is 0.5-10% of the fuel volume.

A process for preparing the activated water-fuel emulsion lies in the following: as a result of cavitation of the fuel in a cavitator with addition of from 0.5% to 40% of the aqueous solution of iron oxides with a concentration of from 0.0001% to 0.1% (the water-fuel emulsion) there is formed a stable 0.5-10% activated water-fuel emulsion that does not break down within at least five days from the time of preparation thereof Then, the activated water-fuel emulsion may be used as a fuel.

The technical effect of the claimed method lies in:
reduction of carbon monoxide emission along with exhaust and flue gases for up to 0%;
reduction of sulfur dioxide emission along with exhaust and flue gases for up to 0%;
reduction of nitrogen oxides emission along with exhaust and flue gases by 30-60% in case of combustion of the treated fuel or the water-fuel emulsion as compared to the emission upon combustion of an initial fuel;
shortening of carbon fuel consumption by 1%-4% in case of activation of the fuel without impurities, and by 4%-10% in case of activation of the fuel with impurities of the aqueous suspension of the iron compounds.

1. A method for reducing harmful and greenhouse gases emission of internal combustion engines and boiler units when using liquid fuels, characterized in that a liquid carbon fuel, before being combusted, is subjected to a physical and chemical transformation by treating thereof in a developed cavitation mode under the temperature of from 0° C. to 70° C. and pressure of from 1 to 3 atm that leads in the fuel combustion process to 100% oxidation of the fuel molecules up to carbon dioxide in a combustion chamber, to reduction of the volume of the fuel consumption for up to 10%, to increase of efficiency of the air oxygen consumption for up to 10% without increase of volumes of consumption thereof that is necessary for combustion of a fuel unit, to increase of the engine or boiler unit performance efficiency for up to 8% that, in turn, in the emission formation process leads to: reduction of a total volume of the greenhouse gases emission for up to 10% during performing a unit of work that is performed by the non-treated fuel and generates 100% of the emission volume; reduction of the concentration of carbon oxide, sulfur dioxide, polycarbonates, solid particles for up to 0%; reduction of nitrogen oxides for up to 30-60% in exhaust and flue gases of internal combustion engines and boiler units.

2. A water-fuel emulsion that consists of a liquid fuel and an aqueous suspension that is characterized in that the suspension consists of mineral iron compounds with a concentration of from 0.0001% to 0.1%, wherein the suspension volume is 0.5-40% of the fuel volume.

3. A method for reducing harmful and greenhouse gases emission of internal combustion engines and boiler units when using liquid fuels that is characterized in that the water-fuel emulsion of claim 2 is subjected to a physical and chemical transformation by treating thereof in a developed cavitation mode under the temperature of from 0° C. to 70° C. and pressure of from 1 to 3 atm that leads to formation of 0.5-10% activated water-fuel emulsion that does not break down within at least five days that in the combustion process leads to 100% oxidation of molecules of the activated water-fuel emulsion up to carbon dioxide in a combustion chamber, to reduction of the volume of the fuel consumption for up to 10%, to increase of efficiency of the air oxygen consumption for up to 10% without increase of volumes of consumption thereof that is necessary for combustion of a fuel unit, to increase of the engine or boiler unit performance efficiency for up to 8% that, in turn, in the emission formation process leads to: reduction of a total volume of the greenhouse gases emission for up to 10% during performing a unit of work that is performed by the non-treated fuel and generates 100% of the emission volume; reduction of the concentration of carbon oxide, sulfur dioxide, polycarbonates, solid particles for up to 0%; reduction of nitrogen oxides for up to 30-60% in exhaust and flue gases of internal combustion engines and boiler units.
